(19) United States
(12) Patent Application Publication
(10) Pub. No.: US 2010/0138243 A1
(43) Pub. Date: Jun. 3, 2010

(54) SYSTEMS AND METHODS FOR FACILITATING HEALTHCARE COST REMITTANCE, ADJUDICATION, AND REIMBURSEMENT PROCESSES

(75) Inventor: Lynn E. Carroll, Jacksonville, FL (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Payformance Corporation, Jacksonville, FL (US)

(21) Appl. No.: 12/572,887

(22) Filed: Oct. 2, 2009

Related U.S. Application Data
(60) Provisional application No. 61/102,322, filed on Oct. 2, 2008.

(51) Int. Cl. G06Q 40/00

(52) U.S. Cl. 705/4

(57) ABSTRACT

A claim processing system, claim processors, and a settlement agency are disclosed for assisting in paying one or more providers. The agency can also provide the providers with an updated claim processing status through updates received from the claim processors. An advantage of this system is that by providing the providers with a common portal or interface in which they find the claim status information; the payers may experience lower call volume, less disputed claims, and frustrated providers.

### PRIORITY CLAIM

This application claims priority under 35 U.S.C. 119(e) from U.S. Provisional Application No. 61/102,322, filed on Oct. 2, 2008, which is incorporated herein by reference.

### FIELD OF THE INVENTION

The present invention relates to health care reimbursement procedures and electronic systems therefor, and more particularly, to a electronic system and information processing methods for use by healthcare providers and payers to interact during the healthcare cost remittance, adjudication and reimbursement processes.

### BACKGROUND

The U.S. healthcare industry is highly regulated with many participants of varying sizes and roles in both the public and private sectors. The current industry serves patients with a compilation of healthcare providers (such as doctors, hospitals, and the like) and payers, whose role is to reimburse either patients or providers for costs incurred by certain patients for services rendered by providers. Common payers include private healthcare insurance companies and government run programs, like Medicare, Medicaid, and state and local level reimbursement programs. Each patient can have different kinds of insurance and different eligibility for government run programs, and will, of course, sometimes use different providers.

The payment reimbursement process for healthcare providers in particular has typically been a time and paper intensive process. Typically, a patient will arrive at the health care facility and present identification and/or proof of insurance and/or proof of enrollment in a public health care reimbursement program. The health care service is provided to the patient, and then typically the patient either pays a known deductible or co-pay, or leaves without tendering any payment.

The health care provider then remits a claim to the insurance carrier to receive the balance of payment due for the services, which the carrier processes, (commonly referred to in the healthcare claim industry as “adjudication”), determines the amount they will pay to the provider for the claim, and settles (these steps commonly referred to in the healthcare claim industry as “adjudication”). In many cases, the insurance carrier will determine that the patient owes more than he or she paid at the time the health care service was provided. For example, the insurance carrier may determine that a certain health care service was provided outside of the pre-negotiated parameters of the patient's coverage plan or exceeds a yearly maximum benefit amount and, therefore, that the patient responsible amount is greater than what was billed to the patient at the time of service. Thus, health care providers are commonly left with the task of reconciling claim adjudication decisions or reimbursement payments received with past service claims in order to determine whether they have been fully compensated for services rendered, and whether to revise and re-submit the rejected claim to the payer (e.g., if there is believed to be a processing or adjudication error) and/or to bill the patient for part or all of the remaining balance. The amount approved by a payer may change many times before a health care provider closes a claim as claims can be resubmitted to payers for adjudication, or payers on their own initiative can review and revise claim adjudications. Further, at any given time, a health care provider will have many open claims at various stages of remittance, adjudication, and reimbursement, producing a complicated financial accounting situation.

The interaction between health care providers and payers are further complicated by the many laws and regulations governing the industry. One significant law regulating the health care industry in particular is the Health Insurance Portability and Accountability Act of 1996 (“HIPAA”). HIPAA, among other things, establishes certain American National Standards Institute (“ANSI”) standards for electronic data interchange (“EDI”) between healthcare providers and payers. This standard is the ACS X12N Implementation guides or technical reports type 3. HIPAA mandates the standardization of EDI formats for health care data transmission, which includes claim submissions, remittance, eligibility and claim status inquiries. HIPAA also requires certain providers to submit Medicare Part B medical claims in a standard HIPAA-approved electronic format.

The current version of the ACS X12 standard adopted by HIPAA, version 4010A1, defines the form and content of different EDI communications, including the 837 Health Care Claim including the institutional, dental and professional versions of the 837, the 835 Electronic Remittance Advice, the 270 Beneficiary Eligibility Inquiry and associated 271 Beneficiary Eligibility Inquiry Response, and the 276 Claim Status Inquiry and associated 277 Claim Status Inquiry Response.

Prior to the implementation of HIPAA, the conventional payment methodologies would typically require substantial time, paperwork, and cost to implement. In particular, excessive time was typically required for delivering and processing physical documents. Overhead costs were incurred for delivering physical documents, such as the cost of postage or a private delivery service and the personnel necessary to administer the handling of such documents. Since HIPAA, communication, submission and processing of claim, adjudication and reimbursement information by and between providers and payers has become largely electronic according to the 4010A1 standard. Providers, however, now spend a great deal of time and other resources processing patient and claim information into electronic format for submission of claims, and reconciling reimbursements with prior submitted claims. Each provider still has to handle and monitor many claims having different combinations of relevant payers (each payer often having their own particular claim form and content requirements and quirks). The process thus remains sufficiently complex that many providers utilize private health care claims clearinghouses to assist in the claim formatting and submission process. Nonetheless, those clearinghouses currently fail to provide providers with an acceptable means to submit claims, monitor claim status, and follow up on adjudicated or rejected claims for revision and resubmission or reconciliation with patient accounts.

Therefore, there is a need in the art for a mechanism to simplify and centralize the health care claim remittance, adjudication, and reconciliation processes. Moreover, there is a need in the art for such a mechanism that more efficiently leverages the information made available via the electronic health care claim EDI communications commonly employed during EDI claim submissions and acknowledgments and mandated by HIPAA.

It is an object of the invention therefore to provide a mechanism for health care providers to track the status of their claim submissions through submission, adjudication, and reconciliation across multiple payers and in substantially real time.

A further object of the present invention is to provide an electronic system and related methods that provide health care providers and payers with a detailed electronic ledger of relevant claims that is automatically compiled and correlated from data made available by EDI according to the 4010A1 standard or future HIPAA mandated standards such as the recently proposed 5010 standard.

Another object of the invention is to provide a system that permits providers to more easily track the status of claims during various stages of the adjudication process of payers, and to match and reconcile subsequent payment disbursements or adjustments from payers with claims.

A still further object of the invention is to provide a system that permits providers to perform primary and secondary claim submission tracking and payment reconciliation across multiple payers.

### SUMMARY OF THE INVENTION

To meet the above and other objects, the present invention provides an electronic system that utilizes EDI communications to compile and correlate an electronic ledger (“user interface”) providing centralized information regarding claim status for a plurality of payers and providers. In accordance with the present invention, there are provided electronic computing systems and related automated processes that provide an electronic health care claim remittance and reconciliation system for use by health care providers and payers. The systems and methods of the present invention provide health care providers and payers with a centralized system to monitor claim and payment status across multiple payers and providers in a standardized manner. The systems and methods of the present invention provide a detailed electronic ledger of relevant claims that is automatically compiled and correlated from data made available by EDI according to the current 4010A1 ACS X12 standard. In particular, the electronic ledger is compiled by tracking and cross-referencing claim remittance, payment, and adjustment EDI communications and claim acknowledgment EDI communications over the entire life of a claim, from submission to final reconciliation.

This present invention as described herein therefore may be embodied as a product offering of a health care reimbursement settlement agency to offer visibility to claims status from the provider's perspective and providing an electronic ledger for all claims submitted to various payers by a given provider. Both the provider and payer will be able to view the electronic ledger information. The electronic ledger provides an interface for clients of the settlement agency to view, for example, by payer acceptance date the acceptance, rejection, initial status of the provider's submitted claim and associated payment information when applicable.

Benefits of the invention over the present state of health care claim remittance, processing and reconciliation include: more rapid disbursement of payment; simplified accounting, record keeping, and management of payments for providers; automated generation of claim re-submissions in the event of rejection due to incomplete claim errors or claim formatting errors; simplified customer care for payers as providers can directly monitor claim status; reduction in administrative and operating costs for providers; and ability for providers and payers to review claim status on a shared interface.

A more detailed description of the invention follows, including an illustrative more detailed description of a few particular embodiments of the invention with respect to several figures.

### BRIEF DESCRIPTION OF THE DRAWINGS

A more complete understanding of the present invention and advantages thereof may be acquired by referring to the following description taken in conjunction with the accompanying drawings in which like reference numbers indicate like features, and wherein:

FIG. 1 is a schematic diagram depicting an overview of the conventional health care claim submission and settlement process known in the prior art;

FIG. 2 is a schematic diagram depicting an overview of a basic health care claim submission and settlement process and system according to embodiments of the present invention;

FIG. 3 is a schematic diagram depicting an overview of a health care claim submission and settlement process and system showing the interaction of a given provider with multiple payers according to embodiments of the present invention;

FIG. 4 is an illustration of a main user view for a sample user electronic ledger interface that may be accessed by a provider to review the claim status and reconciliation data according to one preferred embodiment of the present invention;

FIG. 5 is a logical flow diagram depicting at a high level the flow of information from a provider and a payer into a healthcare claim settlement system of the present invention.

FIG. 6 is a is a logical flow diagram depicting at moderate level of detail the flow of information from a provider and a payer into a healthcare claim settlement system of the present invention.

FIG. 7a and FIG. 7b are linked flow diagrams that collectively depict at an even lower level of detail the logic flow for handling incoming 277 transactions from a payer by a healthcare claim settlement system according to one preferred embodiment of the present invention.

FIG. 8 is a logical flow diagram depicting a process whereby electronic claim remittances, payments, and adjustment information are matched with claim acknowledgment information in preferred embodiments of the present invention; and

FIG. 9 is a logic diagram depicting a data model for associating the data that collected from claim remittance, payment, and adjustment EDI communications and claim acknowledgment EDI communications and thereafter stored in a data warehouse according to a preferred embodiment of the present invention.

FIG. 10 is a schematic view of an embodiment of the invention.

### DETAILED DESCRIPTION OF THE ILLUSTRATED EMBODIMENTS

Embodiments of the present invention include electronic health care claim remittance and reconciliation systems and related methods that provide health care providers and payers with a centralized system to monitor claim and payment status across multiple payers and providers in a standardized manner. The systems and methods of the present invention provide a detailed electronic ledger of relevant claims that is automatically compiled and correlated from data made available by EDI according to the current 1040A1 ANSI standard.

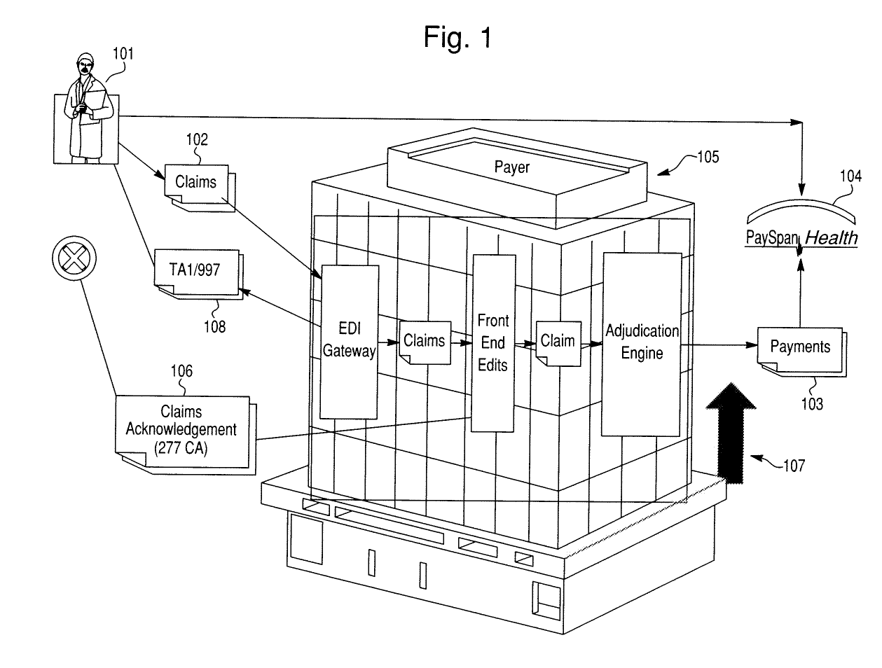

FIG. 1 schematically depicts the current conventional eco system for health care settlement, which is fragmented and suffers from the complexity and transparency issues described above. FIG. 1 depicts the current state of information flows for a given provider 101 and payer 105 from claim 102 submission to payment 103 and ultimate settlement. In many cases this is a black hole with intermediaries involved in the communication and delivery of the claim to the payer 105. A third party electronic health care settlement service 104 (such as PaySpan Health offered by Payformance Corporation of Jacksonville, Fla.) is often used by a typical provider 101 to match payments to claims (i.e., reconciliation). This current common arrangement, however, offers providers virtually no visibility into claims status once a given claim 102 is electronically submitted to the payer 105. Once a claim passes the EDI Gateway of the payer 105 and is accepted for adjudication (the process whereby a payer 101 decides whether to pay a given claim, and how much to pay), the provider's claim enters a virtual black hole until it passes completely through the adjudication process (e.g., often comprising an adjudication engine employing decision trees). After submitting a new claim via EDI, the provider would typically receive an EDI claim acknowledgement 106 known as a “277” EDI transaction but the provider 101 in the conventional system as depicted in FIG. 1 would thereafter know very little regarding the status of their various pending claims until at a much later time (indicated by arrow 107) when a payment disbursement or denial decision is communicated at 103. For sake of simplicity, the diagram of FIG. 1 does not show the other parties that might be involved (such as clearinghouses employed by providers) and shows only a single provider 101 and payer 105. It should be understood that a given provider will interact with many payers simultaneously in this fashion (sometimes for a single claim), and vice versa. These additional parties, of course, merely acerbate the complexity of the claim settlement processes.

In operation, in the common conventional scenario as depicted in FIG. 1, the provider 101 creates a claim 102, which acts similar to an invoice for payment in the health care industry. The provider 101 electronically sends the claim 102 to the payer 105 on behalf of the patient after that patient has presented proof of insurance (or other similar coverage) by the payer 105. As noted above, the claim is sent to the appropriate payer (insurer) via the defined EDI standard. Notably, a single claim could have more than one insurer or payer involved depending on the patients coverage type's and level. Once the claim 102 is received by the payer 105, the payer 105 then passes the claim through several layers of validation known as edits. At any of the edit layers the claim could be sent back to the provider as not valid or non conforming to the claims standards as defined by HIPAA. (For more information concerning HIPAA, see http://www.cms.hhs.gov/TransactionCodeSetsStands)

Until the claim has been accepted into the payer's claim adjudication system (i.e., engine) no payment for the claim is possible. The provider 101 may get a few acknowledgement transactions, such as a TA1 or 997 transaction under the 1040A1 standard, but neither of these give the provider definitive proof that the claim as been accepted into the payer's adjudication engine.

Furthermore, even if the payer 105 does communicate the claims acknowledgement 277 CA 106 back to the claim submitter to articulate the acceptance of a claim into the adjudication engine, most provider's HIS/PMS systems are unable to utilize these EDI transactions and the information they provide. Typically, a payer 105 will send a proprietary format flat file (e.g., ASCII) report to the provider 101 which has to be manually viewed and acted upon. This information is not formatted in the provider's preferred format or view of the data, but rather in the payer's proprietary format, and often times can lack the payer's adjudication ID for the claim. This break down creates the black hole in settlement. Providers 101 are unclear when either contractual or clean claim rules apply, and often providers may wait weeks or months before a lost claim is realized.

By way of background on the 4010A1 standard, the EDI 837 Health Care Claim Transaction set (known conventionally as a “837” communication or transaction in the health care industry) is used to submit health care claim billing information, encounter information, or both. An 837 communication can be sent from providers of health care services to payers, either directly or via intermediary billers and claims clearinghouses. An 837 communication can also be used to transmit health care claims and billing payment information between payers with different payment responsibilities where coordination of benefits is required or between payers and regulatory agencies to monitor the rendering, billing, and/or payment of health care services within a specific health care/insurance industry segment. Many public payers, such as state mental health agencies, mandate that all health care providers and health plans who trade professional (medical) health care claims must do so electronically, such as by for example, using the 837 Health Care Claim: Professional standard to send in claims.

Another EDI transaction defined according to the 1040A1 standard and depicted in FIG. 1 is the 997 Functional Acknowledgement Transaction Set (a “997” transaction or acknowledgement). This transaction set can be used to define the control structures for a set of acknowledgments to indicate the results of the syntactical analysis of the electronically encoded documents. Although 997 transaction is not specifically named in the HIPAA Legislation or Final Rule, it is a commonly known and used transaction in the industry for X12 transaction set processing. The encoded documents for a claim submission are the transaction sets, which are grouped in functional group, used in defining transactions for business data interchange. This standard does not cover the semantic meaning of the information encoded in the transaction sets.

Likewise, the purpose of the TA1 acknowledgement referenced in FIG. 1 is to report the status of the interchange envelope for the transaction submitted by the payer. It will be generated and pushed to the payer's (or whoever submits the claim) system (e.g., FTP site) indicating success or failure of processing a transaction from the ISA to the IEA. It will indicate whether or not there were errors at the ISA or envelope level, but, again, does not necessarily indicate that a claim has been accepted for adjudication.

The other common 4010A1 EDI communication depicted in FIG. 1 is the Health care claim acknowledgement (known commonly as a “277 CA” transaction or communication in the health care industry). This 277 CA transaction set can be used by a health care payer or authorized agent to notify a provider, recipient or authorized agent regarding the status of a health care claim or encounter, or to request additional information from the provider regarding a health care claim or encounter. As shown in FIG. 1, a 277 CA is typically automatically generated by a payer once an electronic claim successfully passes through its EDI Gateway and front end edits. As noted above, this single 277 CA is often the last information a provider receives about a submitted claim until a payment or denial is obtained.

Other EDI transactions defined by the 1040A1 standard, but not regularly utilized in the conventional eco system depicted by FIG. 1, include an EDI Health Care Eligibility/Benefit Inquiry (a “270” transaction or communication) that may be used by providers or their designees to inquire about the health care benefits and eligibility associated with a subscriber or dependent. A corresponding EDI Health Care Eligibility/Benefit Response (a “271” transaction or communication) is also defined that may be used by a payer to respond to a request inquiry about the health care benefits and eligibility associated with a subscriber or dependent.

Similarly, the EDI Health Care Claim Payment/Advice Transaction Set (an “835” transaction or communication) can be used under the 1040A1 standard to make a payment, send an Explanation of Benefits (EOB) remittance advice, or make a payment and send an EOB remittance advice only from a health insurer to a health care provider either directly or via a financial institution.

Importantly for the present invention, the 4010A1 standard also defines an EDI Health Care Claim Status Request (a “276”). This 276 transaction set can be used by a provider, recipient of health care products or services or their authorized agent to request the status of a health care claim. The response to a 276 claim request communication comes in the form of a 277 Response to a health care claim status. The 277 provides information at a summary or service line level of detail. Thus, the 276 request and 277 response transaction set is not intended to replace the Health Care Claim Payment/Advice Transaction Set (835) and, therefore, is not used for account payment posting. Such 277 notifications may be solicited (generated by a provider in response to a 276 request) or unsolicited 277 Unsolicited Health care claim status (e.g., generated periodically by a payer).

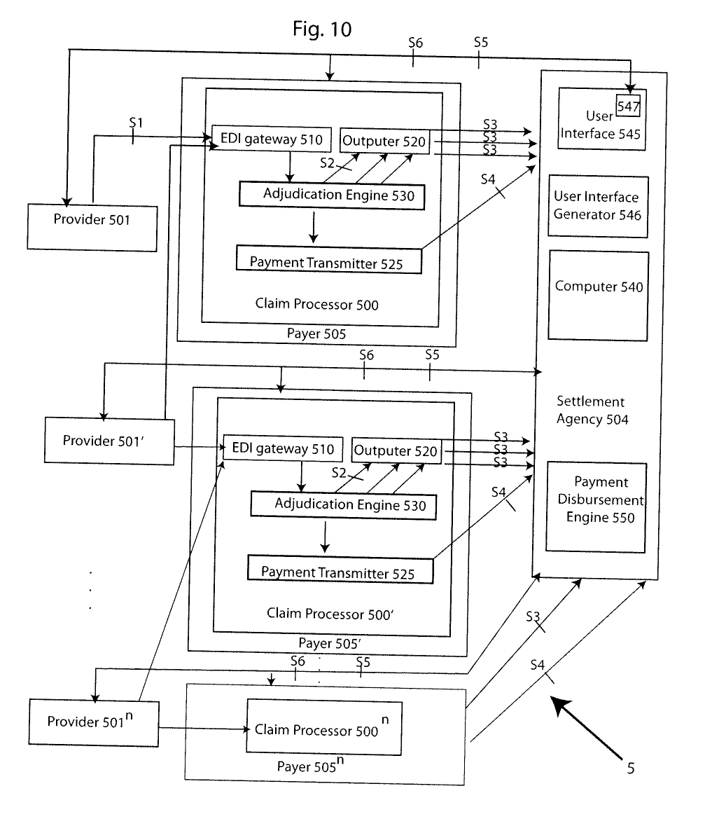

Aspects of the embodiment shown in FIG. 10 create a claim processing system 5 for paying multiple providers using a common settlement agency 504. The agency 504 can also provide the providers with an updated claim processing status through updates received from the claim processors 500. An advantage of this system 5 is that by providing the providers 501 with a common portal or interface 545 in which they find the claim status information; the payers may experience lower call volume, less disputed claims, and frustrated providers.

Looking at FIG. 10, one or more providers (501, 501′, 501ⁿ) may submit a claim to one or more claim processors (500, 500′, 500ⁿ). (The details of the n^{th} processor are omitted to avoid cluttering FIG. 10.) A payer 505 may operate or control one or more of the claim processors. A claim processor 500 may comprise an EDI gateway 510, an outputer 520, a payment transmitter 525, and an adjudication engine 530. The EDI gateway 510 may comprise an input for receiving claims sent S1 from the provider; the EDI gateway may send the claim information to the adjunction engine 530 which may analyze the claim. The adjudication engine 530 may send the outputer 520 information that it has received S2 a new claim. The outputer 520 may receive a status update from the adjudication engine 530, and contain a transmitter for sending S3 one or more transmissions to the settlement agency 504. The payment transmitter 525 may send S4 payments to the settlement agency 504 or to the provider 501 directly; and the adjudication engine 530 may decide whether the provider(s) 501 claim should be paid or denied. The adjudication engine 530 may comprise a logic for deciding to send the payment transmitter 525 a request to send payment; and a decision tree for applying rules to decide whether to pay the particular claim. As the engine processes the claims from a provider 501, the claim processors may use their respective outputer 510 to send updates to the settlement agency 504.

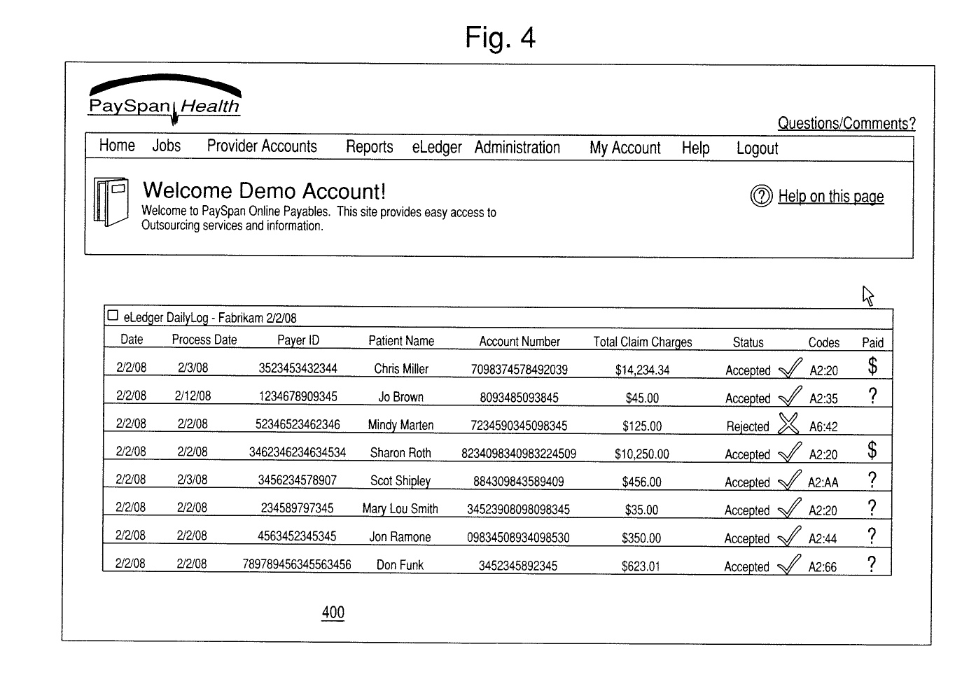

If payment is sent to the settlement agency, the settlement agency 504 may mark the claim as paid, and send S5 a transmission to the provider 501. The settlement agency 504 may contain: an update receiver for receiving update from the claim processor(s); a computer 540 which receives the transmission from the claim processors 500, 500′, 500ⁿ; analysis logic for analyzing and/or formatting the updates a user interface generator 546 for creating a display of the information contained in the updates; a user interface 545 comprising a provider access point 547 for allowing a provider to query the user interface for determining a status of a provider's claim; and a payment disbursement engine 550 for sending payment received from the one or more claim processors to one or more providers. FIG. 4 shows an exemplary user interface the payer or provider may use to monitor claim status. The payer 505 or the provider 501 may access S6 the user interface 545 to receive information about the claim status. The transmissions the settlement agency 504 may receive can comprise a 277 CA transmission or other transmission types which contain enough information for the settlement agency 504 to properly update the claim status of the provider.

The settlement agency 504 and the claim processors 500, 500′, and 500ⁿ may have a set of preestablished formatting rules so that payer(s)' transmission will make it easier for the computer 540 to analyze the transmission. The computer 540 may organize the transmissions into a webpage or display them on a user interface 545 to enable the payer and/or the provider to easily observe the status of the claim.

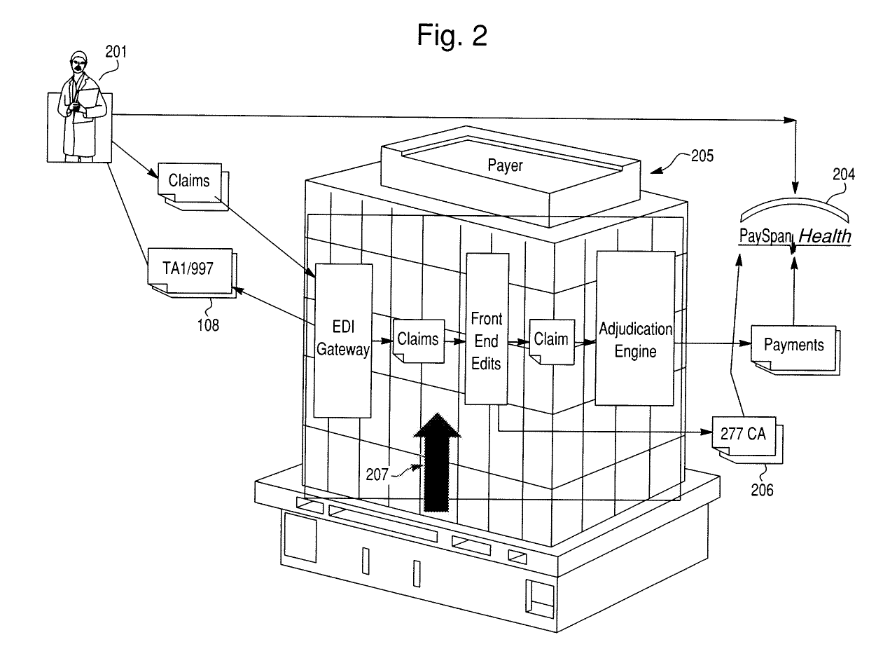

The new settlement approach that underpins the various embodiments of the present invention can be seen generically depicted in the schematic diagram of FIG. 2. The approach of FIG. 2 provides a new level of transparency for the provider by using and digesting 277 transactions in a proactive manner. The embodiments of the invention offers a new method for providers 201 to view the payer's 205 settlement process from the provider's submission perspective, prior to the adjudication. As shown in FIG. 2, the provider 201 (or clearinghouse if a clearinghouse is used to submit claims electronically) will still get directly from the payer 205 EDI system the front end edits of the TA1 and 997 in the same manner they do in the conventional case as depicted in FIG. 1. The present invention, however, provides a new capability to providers in the ability to view the claims acknowledgement (sent as a 277 communication as depicted at 206 in FIG. 2) information even if provider's legacy HIS/PMS systems do not support the EDI transaction natively. The providers have an portal or user interface 545, FIG. 10 created from the perspective of their transmission of the claims, independent of any intermediaries entities involved. This user interface is compiled and managed by a system of a health care settlement agency 204 (e.g., PaySpan Health, also abbreviated elsewhere herein as “PSH”), and made electronically accessible to the provider 201 and to the payer 205. Further, the system 204 also employs 276 request communications to initiate 277 communications at appropriate times to obtain current claim adjudication status information and update the user interface. Thus, the user interface provides insight to the provider 201 at an earlier point (identified by arrow 207 in FIG. 2) of the payer's claim adjudication process.

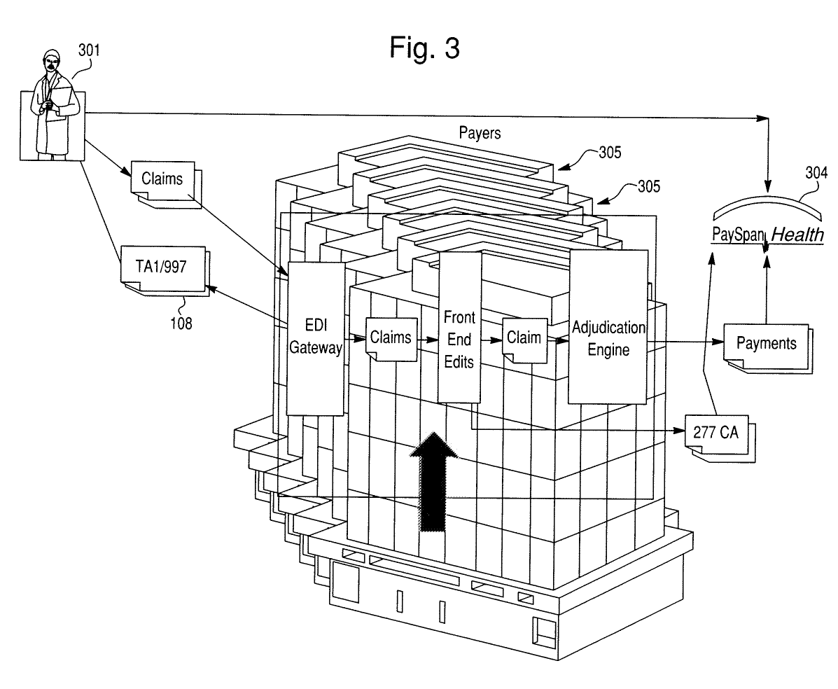

FIG. 3 is a schematic diagram showing how the user interface can accumulate information from multiple payers 305 to provide a provider 301 with a single view of the claims submission process across the multiple payers. The provider 301 thus has access for all claim acceptance/denial decisions across all payers that are connected via the health care settlement system 304. The embodiments of the present invention enables for the first time the settlement process to beneficially utilize the information made available via a 277 claims acknowledgement transaction, thus providing end-to-end visibility of claims to providers. Traditionally the settlement process (i.e., monitoring and matching of payments/denials to claims submitted) begins at end of the adjudication process when adjudication results are received. The user interface of the present invention moves the point where a health care settlement system can begin to track a payer's settlement process to the entry point of the claim from the provider (compare arrow 107 of FIG. 1 to arrow 207 of FIG. 2). The beginning of where the settlement process can be tracked thus becomes the acceptance of the claim into the adjudication system. The user interface provided according to the present invention is unique in the fact that it presents the information back to the provider from the provider's perspective, not the payers. Traditional settlement solutions only offer the data from the payer's adjudication system's perspective, which is disjointed and fragmented from the provider's point of view, and this makes it difficult for provider's to reconcile adjudications with claims.

Using the user interface, pre-rendered payments may also be referred to as the full detail view of the payment/claim payment information. The user interface displays a pre-adjudicated claim's status online for both a payer and provider. The user interface display allows each user to view and search claim information provided by the 277 claim acknowledgement and corresponding disbursement file using a user friendly search engine, sort able informational columns and linked icons.

Turning now to FIG. 4, there is depicted a main user view of a sample user user interface 400 that may be accessed by a provider to review the user interface data. A similar view could be provided to payers. As depicted in the drawing, the user can choose to view all payers, or, alternatively, one at a time from a drop down menu (not shown) in conventional fashion. The provider user at a glance is able to view all claims at a glance and using various sorts or filters to determine which claims have been accepted (e.g., showing a yellow check mark), rejected (e.g., showing a red X), paid (e.g., showing a green dollar sign) or are eligible for a claim status request (e.g., showing an orange question mark).

In use, a provider, for example goes to a web portal for the health care claim settlement system, and activates a “SECURE LOGIN” link. The provider thereafter enters his unique Username and Password and is directed to a main page. The provider can then place his mouse cursor over “Reports” to activate a pull down list. Provider then activates the designated link to the user interface. The user interface display contains sort able claims, icons which indicate claim status and act as a link to a viewable disbursement file or 277 claim acknowledgement. Optionally and preferably, the provider user may be given the capability to export the result of a search directly to a spreadsheet file for a common spreadsheet application by activating a button control entitled, for example, “Excel Export.”

The user interface displays sort able columns entitled Payer Name, Submission Date, Process Date, Patient First Name, Patient Last Name, Patient ID Number, Payer Claim Control Number, Patient Control Number, Service Date, Total Charge, Status and Paid. When a 277 is received from payer it will be indicate a claim as either accepted or rejected as a result of the payer's adjudication process. If the claim is accepted a green “✓” icon/link is populated in the column. If the 277 is rejected a red “x” icon/link is populated in the “Status” column. When activated the “✓” or “x” links will take user to the 277 claim status view document. The user interface also preferably provides payment information in iconic form. If a payment is greater than $0.00, then a “$” icon/link will be displayed in the Paid column on the user interface display. If more than one payment is made on an individual claim a green “$$” icon/link will be placed in the “Paid” column. If a payment is equal to $0.00, then a “0” icon will be displayed in the Paid column on the user interface display. When the either of the links is activated the user is taken to the remittance online display from the claims application.

Similarly, the payer after navigating over the Internet to the portal of the health care claim settlement system and successfully logging in and accessing the user interface, the Payer can elect a search functionality where the payer can designate information to be displayed on user interface. The payer enters search criteria and then activates a search control button and is provided with a similar view 400 as depicted in FIG. 4. If any of the links are activated, the payer user is taken to a remittance online display used for payer claims management.

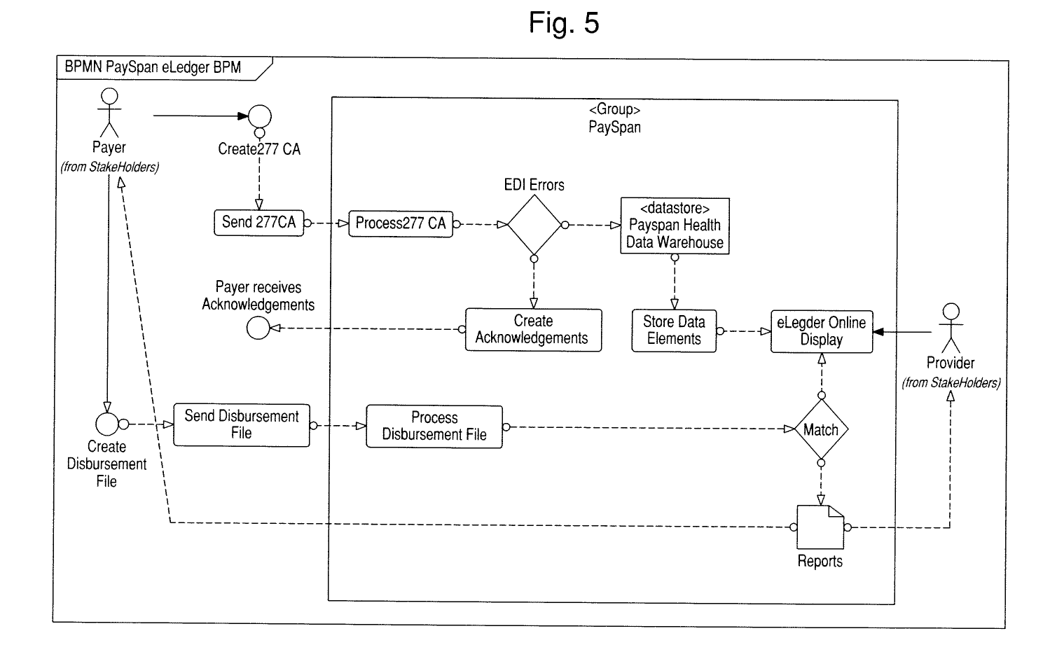

FIG. 5 is a logical flow diagram depicting the high level flow of information from a provider and a payer into a healthcare claim settlement system of the present invention (referred to in FIG. 5 through FIG. 9 interchangeably as PaySpan, PaySpan Health, and PSH). The system of the present invention uses these information flows to compile the user interface described above. As shown in FIG. 5, the PSH system processes 277 communications and payment disbursement files received from the payers, matches them together to match claims with payment and status information, and compiles the matched information into an e-ledger for viewing by both providers and payers. Notably, the systems of the present invention do not need copies of or access to the original EDI claim submission that a provider communicated to a payer in order to compile a full user interface.

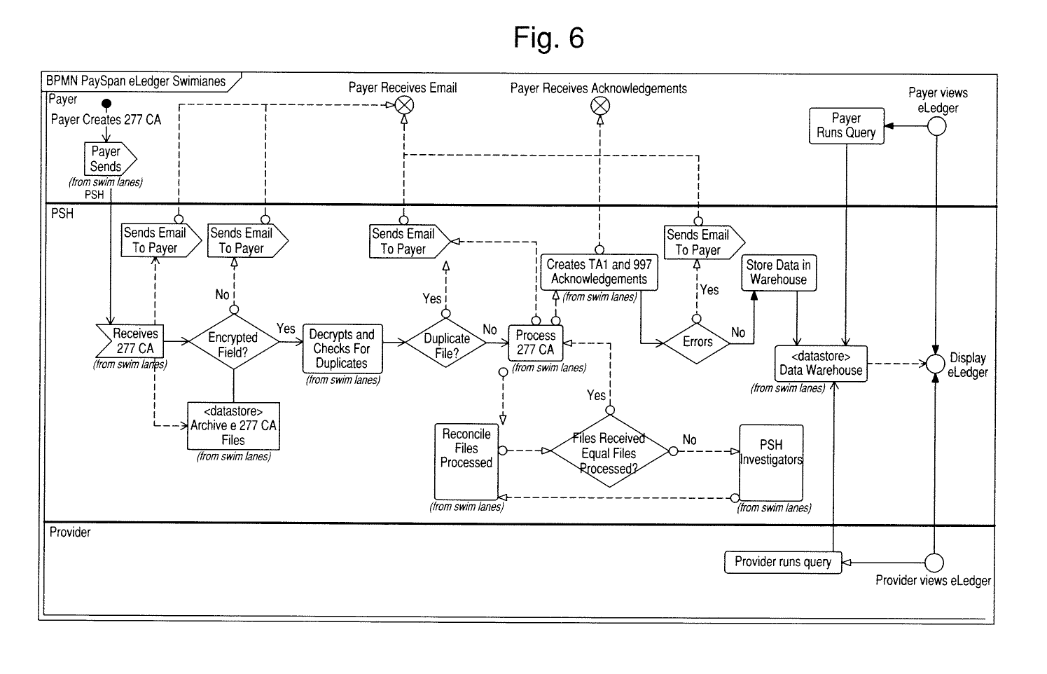

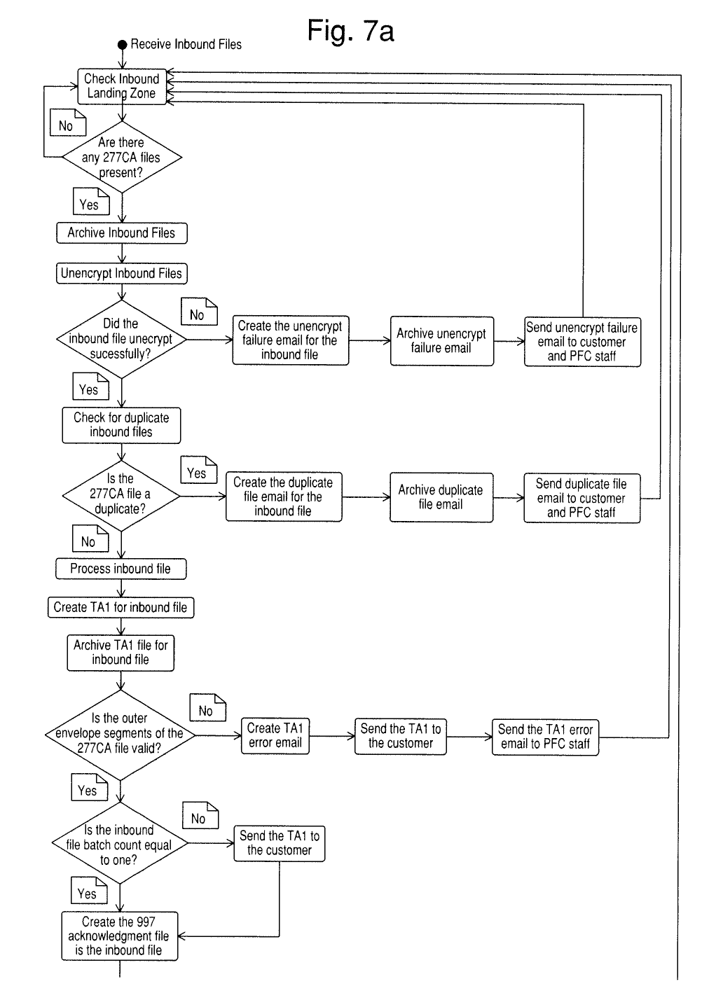

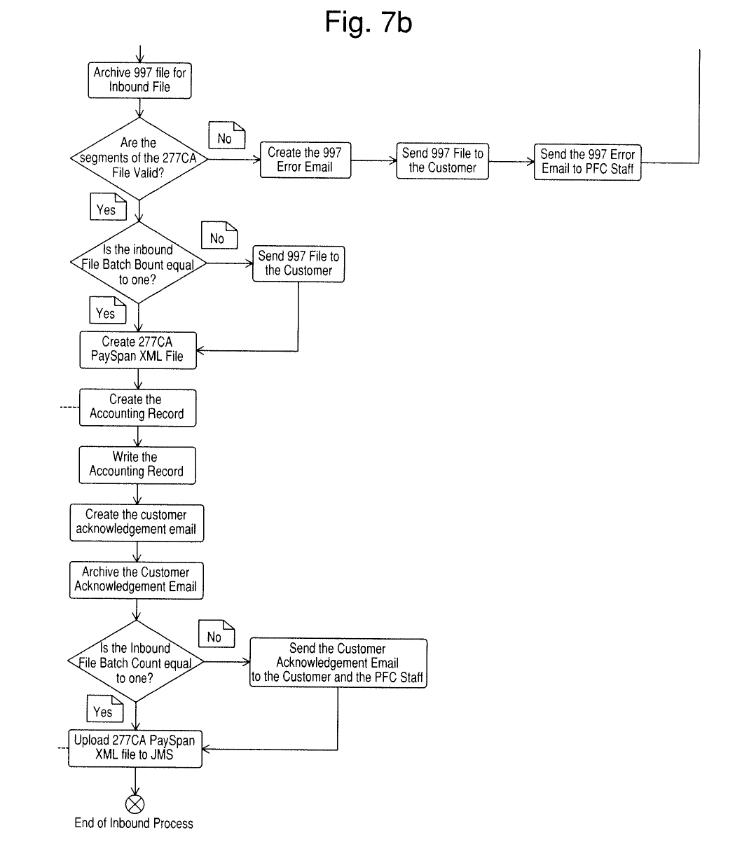

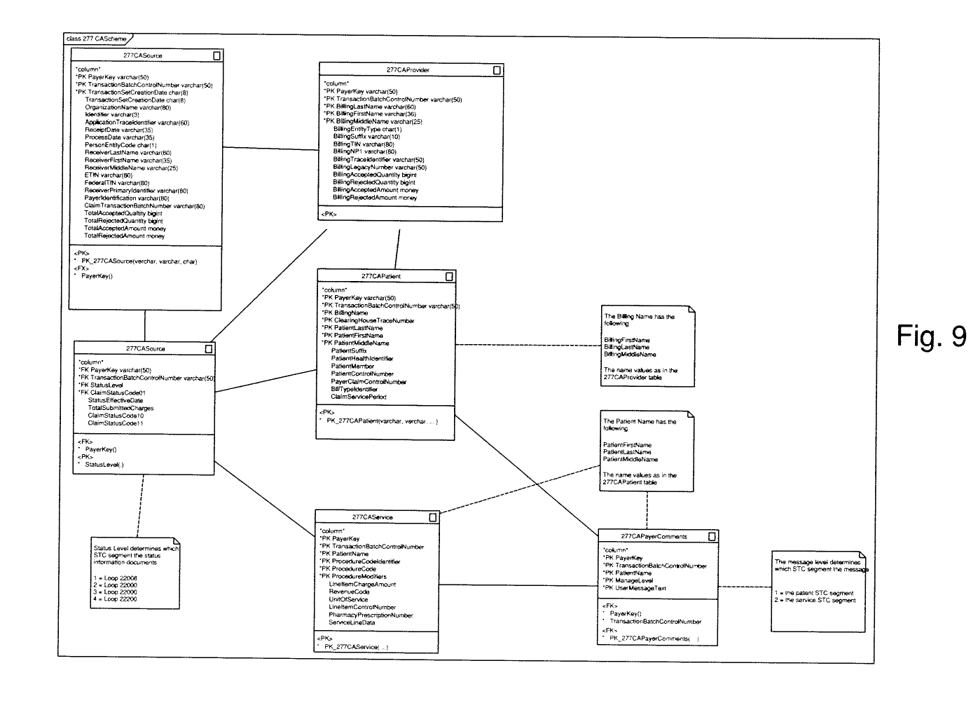

FIG. 6 is a logical flow diagram depicting at a more detailed level the flow of information from a provider and a payer into a healthcare claim settlement system of the present invention. The PSH system of this preferred embodiment of the present invention consumes and processes the 277 as depicted. The standard EDI acknowledgments are utilized with the inbound 277. Typically, a payer will batch and send 277 communications daily to the PSH system. The payer creates a 277 for every claim submitted, and the 277 are produced in a one to one relationship to claims submitted by the provider. The system of the present invention produces a TA1 for each interchange received and a 997 for each functional group received. Eventually, the 277 is accepted and parsed for storage in the data warehouse (e.g., a back end database underpinning the user interface). FIG. 7a and FIG. 7b collectively depict at an even lower level of detail the logic flow for handling incoming 277 transactions from a payer by a healthcare claim settlement system according to one preferred embodiment of the present invention. FIG. 9 shows a data model that describes the data that is stored in the data warehouse in one preferred embodiment of the present invention, consisting of a schema package containing a logical grouping of database tables.

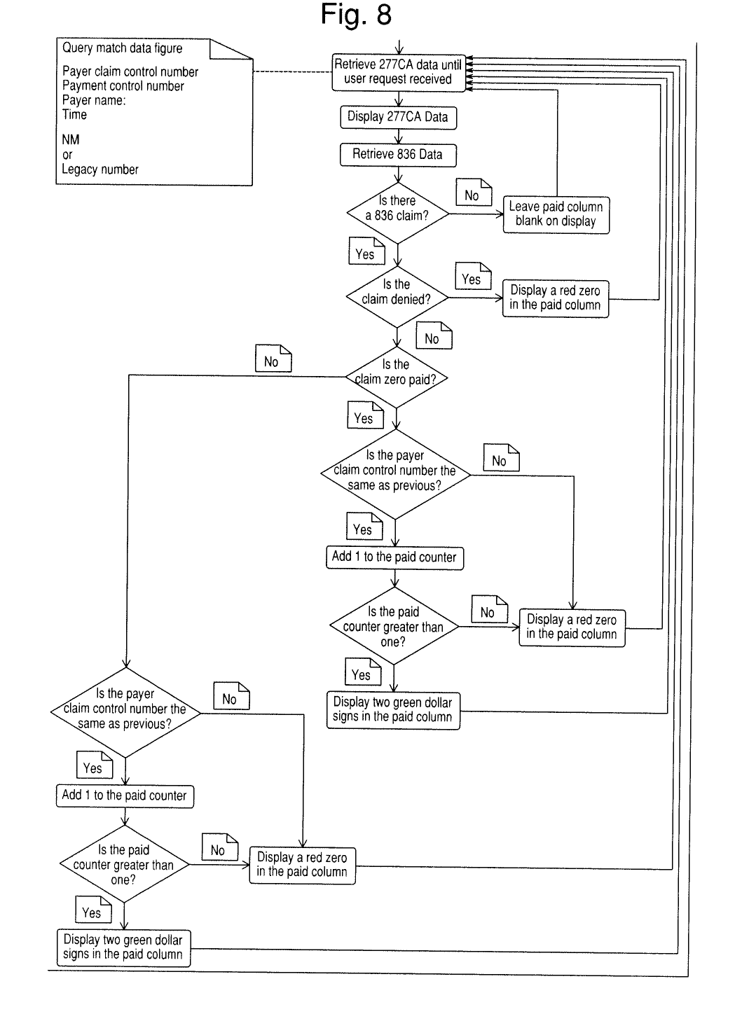

FIG. 8 contains a logical flow diagram depicting how electronic claim remittances, payments, and adjustment information are matched with 277 information in preferred embodiments of the present invention in order to provide users with the user interface view described above. The 835 transaction depicted in FIG. 8 is the X12 transaction mandated under the HIPAA legislation that allows for receiving electronic remittance advice, payments and adjustment information. An 835 communication is contains adjudication data received from a payer.

As depicted in FIG. 8, this embodiment of the health care claim settlement system runs an application (query) which matches the unique identifiers from the received 277 communications to those identifiers in the disbursement files. The payer creates the 277 during the pre-adjudication processing of the 837 Claims. Each file has one ISA/IEA (Interchange) and GS/GE (Functional group). The created 277 acknowledges the validity and acceptability of the claims at the pre-processing stage. During this query match, if an exact match is identified then the data warehouse for the user interface is updated to reflect any payments received. If a payment is greater than $0.00, then a “$” icon/link will be displayed in the Paid column on the user interface display. If more than one payment is made on an individual claim a green “$$” icon/link will be placed in the “Paid” column. When the link is activated the user will be taken to a remittance online display from the claims application. If a payment is equal to $0.00, then a “0” icon will be displayed in the Paid column on the user interface display. When the link is activated the user is taken to the remittance online display used in the claims application.

When a 277 is received from payer it will be either Accepted or Rejected from adjudication. If the claims is accepted a green “?” icon/link is populated in the “Status” column. If the 277 is rejected a red “x” icon/link is populated in the “Status” column. A payer or provider may export the result of a search directly to an spreadsheet program file by activating a button control entitled, for example, “Excel Export.”

The primary vehicle for the claim status information in the 277 transaction is the Status Information (STC) Segment. The level of information returned in the STC Segment may vary from payer to payer. The STC segment contains 3 iterations of the CO43 (Health Care Claim Status) composite within the ST01, STC10 and STC11. The Health Care Claim Status composite (C043) consists of 4 elements. The first element is a Health Care Claim Status Category Code (Code Source 507). The Category Code indicates the level of pre-adjudication status of the claim. The second element is a Health Care Claim Status Code (Code Source 508) that provides more specific information about the claim or line item. The third element is the Entity Identifier Code (ASC X12 data element 98). The fourth and final element is a Code List Qualifier Code (ASC X12 data element 1270).

The payer creates a 277 file that includes unique identifiers (NPI or Legacy Code, TIN, Payer Control Number and Provider Control Number). A 277 when correctly formatted includes one ISA/IEA (Interchange) and GS/GE (Functional group) and is formatted with the correct segment details. The payer packages and names the file using the assigned standard naming convention before sending the file to the health care claim settlement system of the present invention.

Whenever a payer sends a disbursement file or 277, health care claim settlement system stores the gathered data. The health care claim settlement system runs periodically (e.g., hourly) an application (query) which matches the unique identifiers from each 277 to those identifiers in the various disbursement files received from the payer. If an exact match is identified then the user interface is updated to reflect any payments received. If a payment is greater than $0.00, then a “$” icon/link will be displayed in the Paid column on the user interface display. If more than one payment is made on an individual claim a green “$$” icon/link will be placed in the “Paid” column. When the link is activated the user will be taken to a remittance online display from the claims application. If a payment is equal to $0.00, then a “0” icon will be displayed in the Paid column on the user interface display. When the link is activated the user is taken to the remittance online display used in the claims application.

Detailed information regarding one preferred implementation of the present invention is contained in the Model Specification document attached hereto as Appendix A.

It should be readily appreciated by one skilled in the art that the systems and methods disclosed herein, including the user interface, is useful as a foundation for other features and functionality of a health care claim settlement system. It is a foundation interface and data collection and aggregation system for supporting a claims status and request products, for real time adjudication (or estimated adjudication) of claims, coordination of benefits among multiple payers, and automated claim resubmission feature. It can also be used to automatically monitor clean claim horizons.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention. Having thus described the various illustrative and preferred embodiments of invention, the scope of the invention should be limited only by the claims that shall issue in the application.

It is claimed:

1. A claim processor for sending updates and payments to a settlement agency; said processor comprising:
a. an EDI gateway for receiving a claim transmission from a provider;
b. a payment transmitter for sending a payment to the settlement agency;
c. an adjudication engine for receiving the claim transmission from the EDI gateway; said adjudication engine comprising a logic for deciding whether to send the payment transmitter a request to send payment for a particular claim and a decision tree for applying rules to decide whether to pay the particular claim; and
d. an outputer for receiving a status update from the adjudication engine; said outputer comprising a transmitter for sending the status update to the settlement agency.

2. A settlement agency for providing information to one or more providers and disbursing payment to the one or more providers; said agency comprising:
a. an update receiver for receiving updates from one or more claim processors; a computer for receiving the updates from the update receiver; said computer containing analysis logic for analyzing the updates;
b. a user interface generator for creating a display of information contained within the updates;
c. a user interface comprising a provider access point for allowing a provider to query the user interface for determining a status of a provider's claim;
d. a payment disbursement engine for sending payment received from the one or more claim processors to one or more providers.

3. A claim processing system comprising:
a. a settlement agency for providing information to one or more providers and disbursing payment to the one or more providers; said agency comprising:
i. an update receiver for receiving updates from one or more claim processors;
ii. a computer for receiving the updates from the update receiver; said computer containing analysis logic for analyzing the updates;
iii. a user interface generator for creating a display of information contained within the updates;
iv. a user interface comprising a provider access point for allowing a provider to query the user interface for determining a status of a provider's claim;
v. a payment disbursement engine for sending payment received from the one or more claim processors to one or more providers;
b. one or more claim processors for sending updates and payments to the settlement agency; said one or more claim processors comprising:
i. an EDI gateway for receiving a claim transmission from a provider;
ii. a payment transmitter for sending a payment to the settlement agency;
iii. an adjudication engine for receiving the claim transmission from the EDI gateway; said adjudication engine comprising a logic for deciding whether to send the payment transmitter a request to send payment for a particular claim and a decision tree for applying rules to decide whether to pay the particular claim; and
iv. an outputer for receiving a status update from the adjudication engine; said outputer comprising a transmitter for sending the status update to the settlement agency.
